(19) United States
(12) Patent Application Publication
(10) Pub. No.: US 2026/0093972 A1
(43) Pub. Date: Apr. 2, 2026

(54) LAYER-WISE PRECISION OPTIMIZATION IN ANALOG COMPUTE-IN-MEMORY ACCELERATORS

(71) Applicant: Intel Corporation, Santa Clara, CA (US)

(72) Inventors: Shamik Kundu, San Jose, CA (US); Arnab Raha, San Jose, CA (US); Richard Dorrance, Beaverton, OR (US); Deepak Abraham Mathaikutty, Chandler, AZ (US); Brent Carlton, Portland, OR (US)

(73) Assignee: Intel Corporation, Santa Clara, CA (US)

(21) Appl. No.: 19/413,190

(22) Filed: Dec. 9, 2025

Related U.S. Application Data
(60) Provisional application No. 63/869,647, filed on Aug. 25, 2025.

(51) Int. Cl. G06N 3/065; G06F 15/78

(52) U.S. Cl. CPC G06N 3/065; G06F 15/7821

(57) ABSTRACT

It is not optimal to apply analog compute-in-memory circuitry (ACiM) for all layers of a neural network or to apply digital compute-in-memory (DCiM) circuitry for all layers of the neural network, due to the tradeoff between efficiency and precision. To address this challenge, a layer-wise offloading strategy can selectively execute neural network layers using either DCiM circuitry or ACIM circuitry based on signal and statistical sensitivity conditions. The approach leverages a combined heuristic, incorporating both the number of input channels meeting a signal sensitivity criterion and the statistical properties of the weight distribution meeting a statistical sensitivity criterion. Layers are allocated to DCiM when both conditions are satisfied, while layers are allocated to ACIM if either or both conditions are not met. The approach optimizes computational efficiency by dynamically assigning resources according to input characteristics and distributional metrics.

### PRIORITY APPLICATION

This patent application claims priority to and/or receives benefit from U.S. Provisional Application No. 63/869,647, filed on 25 Aug. 2025, titled “LAYER-WISE PRECISION OPTIMIZATION IN ANALOG COMPUTE-IN-MEMORY ACCELERATORS.” The US Provisional application is hereby incorporated by reference in its entirety.

### BACKGROUND

Von Neumann architectures suffer from a memory wall problem for artificial intelligence (AI) applications such as execution of deep neural networks (DNNs), because workloads for AI demand energy-intensive data transfers. Compute-in-memory (CIM) technologies have been introduced to address challenges in von Neumann architectures. Specifically, CiM technologies allow computations to be performed directly within or very close to where the data is stored. Digital compute-in-memory (DCiM) and analog compute-in-memory (ACiM) perform data processing in the digital domain and in the analog domain respectively, directly within or next to memory units rather than shuttling data back and forth between separate memory and processing units. CiM implementations can employ non-volatile memory technologies. DCiM employ digital circuits that perform digital computations directly within the memory array. ACIM employ mixed-signal circuits and data converters that can enable analog computations to be performed directly within the memory array.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates a computing system having a compiler and a DNN accelerator, according to some embodiments of the disclosure.

FIG. 2 illustrates a compute engine having DCiM circuitry and ACiM circuitry, according to some embodiments of the disclosure.

FIG. 3 illustrates an ACiM macro, according to some embodiments of the disclosure.

FIG. 4 illustrates layer information profiling and logic for determining whether a layer is to be executed on DCiM circuitry or ACiM circuitry, according to some embodiments of the disclosure.

FIG. 5 illustrates distributions having the same mean and standard deviation, but different kurtosis, according to some embodiments of the disclosure.

FIG. 6 illustrates selecting a subset of layers in ResNet-50 to be executed on DCIM circuitry, according to some embodiments of the disclosure.

FIG. 7 is a flow diagram illustrating a method for compiling a neural network model to be executed on a neural network accelerator, according to some embodiments of the disclosure.

FIG. 8 depicts a block diagram of an exemplary computing device, according to some embodiments of the disclosure.

### DETAILED DESCRIPTION

### Overview

ACIM architectures have emerged as a promising alternative or complementary to other types of digital accelerators for DNNs, offering significantly higher energy efficiency and computational density by eliminating the need to shuttle data between memory and compute units. However, their practical deployment remains limited by a fundamental tradeoff between efficiency and precision. The tradeoff is primarily dictated by the resolution of the Analog-to-Digital Converters (ADCs) that convert analog signals to digital signals.

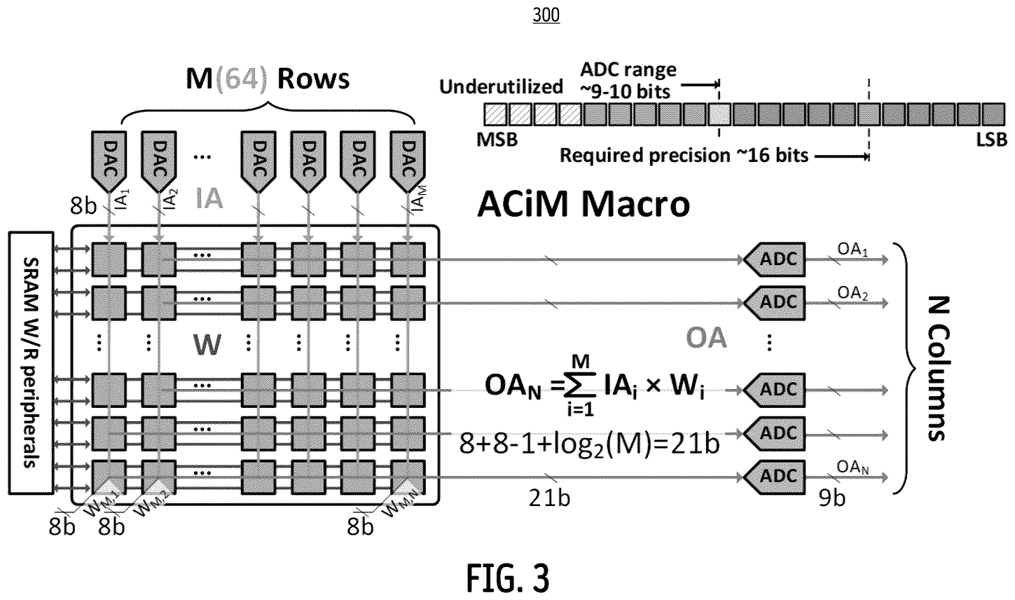

In an ACiM macro (illustrated in FIG. 3 in greater detail), the accumulated result from dozens of multiply-accumulate (MAC) operations is digitized by a shared ADC. Although such architectural designs maximize analog reuse, they also amplify the impact of ADC quantization errors, especially when high-precision outputs are desired. This problem is exacerbated in large-scale neural networks such as ResNet-50 or MobileNet-V2. For example, even though each 8-bit integer precision (INT8) MAC in theory generates up to a 21-bit output after accumulation, a low-resolution ADC (e.g., 8-10 bits) truncates the lower significant bits, leading to notable accuracy loss. While some loss in precision is tolerable, up to five bits can be dropped in certain networks without exceeding a 1% top-1 accuracy degradation. In applications where high accuracy is required, the ACIM macro may need an ADC with higher ADC resolution (e.g., 12 bits or more), which can introduce power and latency overheads that undermine the energy benefits of ACiM. Moreover, real-world ADCs rarely achieve their nominal resolution due to non-idealities like thermal noise, integral (INL) and differential (DNL) non-linearity errors, and bandwidth limitations, further compromising output fidelity.

Another key challenge lies in the mismatch between theoretical bit-width requirements and actual signal utilization. In practice, the accumulated analog outputs often exhibit small dynamic range due to the normal distribution of weights and zero-padding of inputs. The accumulated analog outputs can often have small dynamic ranges especially in early convolution layers with low input channel counts. This results in underutilization of the ADC's dynamic range and increased susceptibility to quantization noise.

For at least some of these reasons, applying the same ADC precision uniformly across all layers leads to a highly inefficient design because some layers demand high resolution to preserve accuracy, while others do not justify the cost. Moreover, it is not optimal to use ACiM circuitry for all layers of a neural network or to use DCiM circuitry for all layers of the neural network, due to the tradeoff between efficiency and precision.

To address at least some of these issues, a layer-wise offloading strategy can be implemented. In particular, the layer-wise offloading strategy, determines on a per layer basis, based on information about the layer, whether to execute the layer using ACIM circuitry or DCIM circuitry. By default, a layer is to be executed using ACIM circuitry to achieve optimal power efficiency. However, if a layer is determined to be too sensitive to the precision issues of ACiM circuitry, the layer can be offloaded to be executed by the DCiM circuitry. In some embodiments, the strategy would assign a layer to be executed on more power efficient circuitry with reasonable precision (e.g., ACiM circuitry), and would not offload the layer to be executed on higher-precision circuitry (e.g., DCiM circuitry or ACIM circuitry with higher-resolution ADCs) unless deemed sufficiently necessary.

In some embodiments, the layer-wise offloading strategy is implemented in a compiler that compiles a neural network model to be executed on a neural network hardware accelerator. The compiler runs offline to prepare executable machine-readable instructions/configurations for the target neural network hardware accelerator. The compiler receives detailed information pertaining to each layer of the neural network model. This information may include, but is not limited to, the number of input channels present in the layer and the statistical distribution of the weights associated with the layer. Utilizing this information, the compiler evaluates and determines the optimal execution path for each layer. Specifically, the compiler decides whether a given layer should be executed by DCIM circuitry or ACiM circuitry within the neural network accelerator. Following the determination, the compiler generates one or more machine-readable configurations for the operations of the layer. These configurations are generated according to whether the layer is allocated to the DCIM or ACiM circuitry, to cause each layer to be executed on the decided execution path.

The layer-wise offloading strategy can selectively execute neural network layers using either DCiM circuitry or ACiM circuitry based on signal and statistical sensitivity conditions. The approach leverages a combined heuristic, incorporating both the number of input channels meeting a signal sensitivity criterion and the statistical properties of the weight distribution meeting a statistical sensitivity criterion. Layers are allocated to DCiM when both conditions are satisfied, while layers are allocated to ACIM if either or both conditions are not met. The approach optimizes computational efficiency by dynamically assigning resources according to input characteristics and distributional metrics. Phrased differently, the layer-wise offloading strategy partitions the workload between ACIM and DCiM based on each layer's sensitivity to ADC precision.

Layers with small input channel counts or stringent precision demands, such as the first convolution layer in ResNet or MobileNet, can be redirected to a digital core having DCIM circuitry to increase precision while decreasing efficiency. If available in the hardware, those layers can be redirected to a dedicated analog core having ACiM circuitry equipped with higher-resolution ADCs to increase precision while decreasing efficiency. Meanwhile, layers with greater tolerance to quantization noise remain on the main ACIM datapath with low-resolution ADCs and optional local scaling. In some implementations, the ACIM datapath can apply output analog scaling techniques, where careful signal conditioning of the analog input to the ADC and post-processing of the digital output of the ADC could close the precision gap in ACiM.

By avoiding global overprovisioning of ADC precision, the layer-wise offloading strategy not only improves overall inference accuracy but also preserves the energy benefits of ACiM. The result is a hybrid inference pipeline that strategically allocates compute resources based on precision-criticality, achieving an optimized balance between accuracy and efficiency.

Implementing a layer-wise offloading strategy is not trivial. Various embodiments and examples of the layer-wise offloading strategy have one or more technical contributions.

One contribution relates to precision-aware offloading via structural and statistical heuristics. A dual-criteria method can be implemented. The method identifies layers that are vulnerable to quantization-induced degradation in ACIM systems. The method jointly evaluates: (i) structural information about the layer and (2) statistical information about the distribution of the weights of the layer. Structural information can include the number of input channels (ICs) relative to the analog accumulation width. Statistical information about the distribution of the weights can include the standard deviation and the kurtosis of the layer's weight distribution. Layers that both underutilize analog MAC paths and whose weight distribution exhibit one or more characteristics (e.g., standard deviation exceeding a critical threshold and a flat-tailed weight distribution) are flagged for offloading to full-precision DCiM circuitry or higher-precision ACIM circuitry.

Another contribution relates to using input channel-based analog underutilization detection as a structural heuristic. The ACM macro can perform accumulation over IC_{acc}=128 input channels per column. Layers with IC counts≤IC_{acc}/2=64 can be classified as underutilizing the analog fabric, engaging ≤50% of available accumulation depth. The layer IC count being less than a threshold, e.g., half of ICs being accumulated, can lead to lower signal amplitudes and ineffective utilization of ADC dynamic range, increasing relative quantization error and reducing inference fidelity. Such layers can be prioritized for digital or higher-precision execution.

Another contribution relates to using offline kurtosis-guided weight sensitivity profiling as a statistical heuristic. Kurtosis, i.e., a normalized fourth central moment, of a distribution can be used as a statistical sensitivity or fragility metric for weight distributions. Layers with high or positive excess kurtosis are more prone to collapse under fixed-resolution ADC quantization, as their output distributions have high-energy tails. These statistically fragile layers can be identified offline and incorporated into the offloading plan for digital or higher-precision execution.

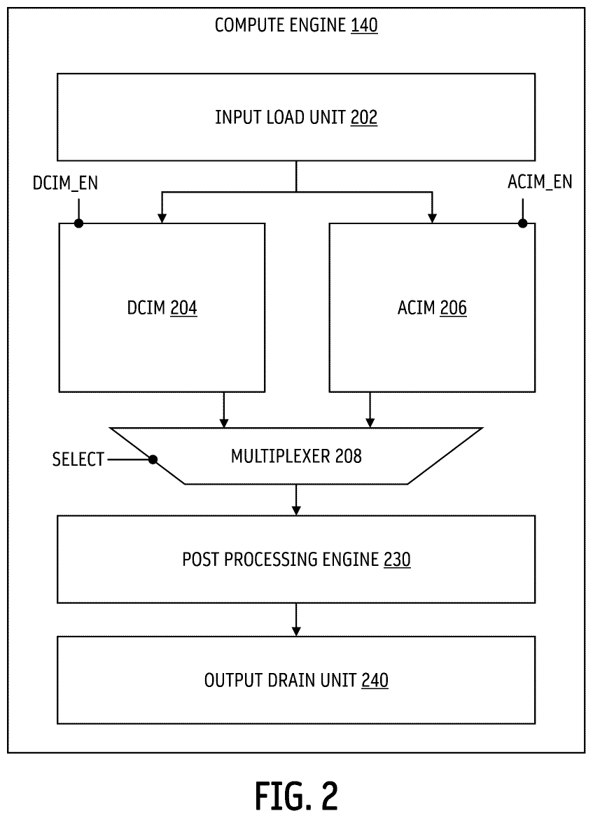

Another contribution relates to hybrid analog-digital layer execution model and hardware that supports having two execution paths, one with higher-precision and lower power efficiency circuitry (e.g., DCiM circuitry) and one with lower precision and higher power efficiency circuitry (e.g., ACIM circuitry). An illustration of the two-path execution framework is shown and described with FIG. 2. In some embodiments, the compiler can map each layer to either the ACIM circuitry for energy-efficient accumulation with low-resolution ADC, or to a DCIM circuitry capable of full-precision computation. The compiler can centrally select one of the two execution paths based on layer sensitivity and co-optimize power and precision for a given application effectively.

Another contribution relates to the layer offloading strategy being able to achieve accuracy-efficiency tradeoff at deployment time. Experimental results on ResNet-50 demonstrate that the hybrid offloading strategy, e.g., when applied to a portion of the layers, can recover most of the full-precision Top-1 accuracy, while sustaining a significant Tera Operations per Second per Watt (TOPS/W) advantage over baseline digital-only execution. This architecture exposes a tunable tradeoff surface, enabling deployment time selection of Pareto-optimal operating points for resource-constrained inference systems.

### Technical Advantages Over and Comparisons Against Other Solutions

Efforts to balance accuracy and efficiency in ACiM systems involve signal enhancement at the analog interface or fallback mechanisms in digital computation. Methods like local scaling and gain control help stretch signals within ADC range but only offers partial mitigation when analog signal levels are inherently weak due to low accumulation depth.

Adaptive ADC resolution per layer adds flexibility but increases area, power, and latency costs, while global high resolution ADCs preserve accuracy at the expense of energy efficiency. System-level fallback, where entire models or sub-networks are routed to DCiM or digital accelerators when analog precision is insufficient (e.g., an all-or-nothing approach), ensures accuracy but lack granularity and results in highly conservative designs that leave significant efficiency on the table.

Surveys show that despite energy-saving prototypes, real-world ACIM chips often adopt conservative strategies to maintain accuracy. Previous architectures highlight ongoing challenges with noise, limited precision, and ADC bottlenecks.

Some approaches combine leverages Singular Value Decomposition (SVD) and gradient redistribution to restructure transformer weight matrices such that the most critical components are allocated to high-precision single-level cell arrays, while the majority are mapped to more efficient multi-level cell arrays. This enables fine-grained control over storage precision and preserves accuracy even when aggressive analog compression is applied.

Some approaches addressing the accuracy-efficiency tradeoff suffer from limitations that restrict their applicability and scalability. Techniques like local gain scaling or dynamic ADC adjustment operate at a low level and are agnostic to the broader structural or statistical properties of the network layers. As a result, they may be ineffective in scenarios where analog underutilization is structural—for instance, in convolutional layers with a low number of input channels-leading to poor ADC utilization and signal-to-noise ratios that scaling alone cannot correct. Similarly, dynamic ADC strategies impose non-negligible power and control complexity, especially when switching across wide bit-depths during runtime.

While some approaches offer co-design between algorithm and hardware, those approaches are limited by its tight coupling to transformer architectures and its reliance on static weight matrices. In those approaches, the decomposition and retraining process is computationally expensive and ill-suited for models with varying sensitivities across layers, such as convolutional neural networks like ResNet-50 or MobileNet-V2. Moreover, it does not consider the role of analog hardware underutilization (e.g., low accumulation width utilization) in driving quantization error, instead focusing exclusively on weight importance redistribution. This makes it less effective in early network layers where structural inefficiencies dominate.

Furthermore, none of the approaches jointly consider both structural factors (such as input channel count relative to analog accumulation depth) and statistical factors (such as kurtosis and standard deviation of weight distributions) in determining precision requirements. As a result, their fallback or precision-enhancing strategies are either overly aggressive (leading to energy and area inefficiencies) or too conservative (resulting in avoidable accuracy loss).

In contrast, the approach described herein introduces a layer-wise hybrid execution model that leverages both structural profiling and statistical sensitivity analysis to selectively offload only the most precision-critical layers to a full-precision DCiM path. By combining input channel-based profiling with kurtosis-guided weight analysis, the system identifies layers that are both structurally underutilized and statistically fragile, and routes them to a high-precision path, while allowing the remaining layers to benefit from the energy efficiency of low-resolution analog computation. This strategy precisely tunes of the accuracy-efficiency tradeoff at deployment time, without requiring extensive retraining or runtime configuration, and offers a scalable, generalizable solution across diverse network architectures.

The approach described herein introduces a precision-aware hybrid execution framework for ACiM accelerators, where each neural network layer is selectively offloaded to a DCIM path based on its structural and statistical sensitivity to quantization noise. By combining input channel-based underutilization analysis with kurtosis-guided profiling of weight distributions, the system identifies precision-critical layers and routes them to high-fidelity computation, while preserving the energy efficiency of analog processing for robust layers. This approach allows deployment time tradeoff tuning between accuracy and throughput-per-watt, without requiring hardware modification or full-model fallback.

TOPS/W remains a key metric for evaluating energy efficiency in AI accelerators, particularly in edge and client markets where power budgets are constrained. The approach described herein enables layer-wise precision optimization in CiM architectures, recovering most of full-precision accuracy while maintaining significant TOPS/W advantage over digital baselines, thereby unlocking analog efficiency without compromising correctness. By avoiding global overprovisioning and enabling targeted digital fallback, the solutions implementing the approach can deliver high-throughput, low-power AI platforms that scale across form factors and workloads.

The hybrid offloading strategy, which combines both structural and statistical heuristics, delivers a balanced and highly favorable tradeoff, recovering most of the lost Top-1 accuracy while still retaining significant energy efficiency improvement (for ResNet) over digital-only execution. This configuration selectively offloads only the most vulnerable layers, e.g., those with low IC count and high kurtosis weight distributions, to a full-precision DCIM execution path, while allowing the remaining layers to run on the analog execution path. This dual-path approach represents the Pareto-optimal point on the accuracy-efficiency curve, maximizing energy savings without compromising model fidelity.

The broader efficiency gains highlight the strength of targeted offloading. Instead of reverting entire models to digital execution (which negates analog benefits) the approach described herein offloads only those layers where precision degradation is inevitable and impactful. By avoiding unnecessary or overaggressive digital fallback, throughput and power advantages of analog acceleration are retained while introducing precision only where it is essential.

In some embodiments, this granular control also unlocks deployment time flexibility: for resource-constrained edge scenarios, users can bias toward energy savings by reducing the number of offloaded layers; for accuracy-critical use cases, more layers can be rerouted with diminishing returns on energy loss. This exposes a tunable design knob that enables system integrators to explore optimal operating points depending on their application, hardware constraints, and service-level requirements. The hybrid precision-aware execution strategy offers not just a fixed solution but a scalable and configurable design space, enabling adaptive deployment across a spectrum of AI hardware platforms, from ultra-low-power edge inference to high-performance on-chip accelerators, while maintaining statistical robustness and architectural efficiency.

### a Compiler Implementing the Layer-Wise Offloading Strategy

Despite the efficiency gains promised by ACIM architectures, achieving high inference accuracy in deep neural networks remains a formidable challenge due to analog signal degradation and quantization noise introduced by low-resolution ADCs. Other approaches explored techniques such as local scaling and adaptive gain control to reduce signal range mismatches and improve dynamic range utilization at the ADC input. However, these methods only partially mitigate the precision gap, particularly for layers that are inherently more sensitive to quantization. Simply increasing the resolution or bandwidth of ADCs is not a scalable solution: higher-resolution ADCs consume significantly more power, require larger area, and introduce latency due to oversampling and successive approximation cycles. As a result, the ACIM circuitry becomes a bottleneck when uniform treatment is applied across all network layers.

To address these shortcomings, a more granular, layer-wise approach to computation mapping can be integrated within a compiler. Instead of mapping and executing all layers uniformly on a low-resolution ACIM circuitry, the compiler selectively offloads precision-critical layers, e.g., those that exhibit poor tolerance to ADC quantization error, to a full-precision DCiM circuitry (or higher-precision ACiM circuitry). Unlike traditional digital cores, the DCiM circuitry retains much of the memory-centric compute efficiency of ACIM while offering accurate accumulation and quantization-free signal representation. This allows the DCIM circuitry to serve as a precision fallback path for sensitive layers. By routing only the most vulnerable layers to the DCiM circuitry, high accuracy is maintained where needed, while allowing the majority of layers to continue operating on the low-resolution ACIM circuitry. This hybrid execution model preserves the energy and throughput benefits of analog computing for robust layers, while guaranteeing correctness for sensitive ones, without incurring the system-wide overhead of uniformly deploying high resolution ADCs.

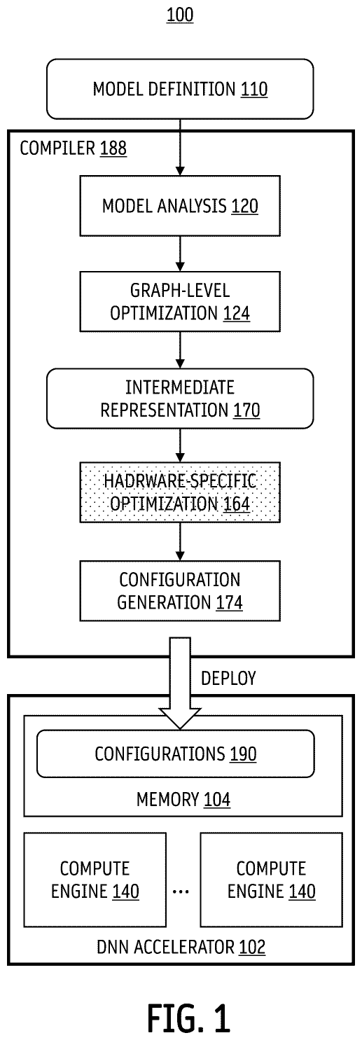

FIG. 1 illustrates computing system 100 having compiler 188 and DNN accelerator 102, according to some embodiments of the disclosure.

Compiler 188 can include one or more of: model analysis 120, graph-level optimization 124, hardware-specific optimization 164, and configuration generation 174. Compiler 188 orchestrates the transformation of model definition 110 into hardware-executable instructions, such as configurations 190. Compiler 188 can implement layer-wise offloading strategies described and illustrated herein. Compiler 188 is responsible for analyzing the neural network (e.g., based on information in model definition 110), optimizing its structure, and generating configurations 190. Compiler 188 can perform selective mapping of layers to different execution paths of DNN accelerator, to maximizing both accuracy and energy efficiency.

Model definition 110 can include a high-level specification of a deep neural network. Model definition 110 serves as the input to compiler 188. Model definition 110 can include the architectural information of the model, such as the types and sequence of layers (e.g., convolutional, fully connected, normalization, activation), the connectivity between layers, structural information about the dimensionality of inputs and outputs, and the weights of the model. Model definition 110 may specify hyperparameters like kernel sizes, strides, padding, activation functions, and initial weight values. In addition to model details, model definition 110 can include metadata relevant to deployment, such as target accuracy, latency constraints, and resource budgets. This information can allow compiler 188 to tailor optimizations and hardware mappings to meet specific application requirements. Model definition 110 may be expressed in a syntax of a machine learning libraries like TensorFlow or PyTorch. Model definition 110 provides the information for subsequent analysis, profiling, and optimization. Model definition 110 allows compiler 188 to identify layers that are structurally and statistically sensitive to hardware limitations, such as analog quantization noise or ADC underutilization. By parsing model definition 110, compiler 188 can apply precision-aware layer offloading strategies to map operations of each layer on the most suitable hardware circuitry for optimal accuracy and efficiency.

Model analysis 120 can include parsing model definition 110 can produce a graph representation of the neural network. This process involves reading the high-level specification in model definition 110 and converting the specification into a structured computational graph, where nodes represent operations or layers and edges represent data dependencies between them. The resulting graph provides a clear and manipulable format for subsequent optimization and transformation steps within compiler 188. Model analysis 120 accurately translates the model's architecture specified in model definition 110 into a graph that serves as the foundation for further compilation stages in compiler 188.

Graph-level optimization 124 can include transformations on the computational graph derived from model analysis 120. Graph-level optimization 124 can perform operator fusion, pruning, and reordering to improve computational efficiency and reduce memory usage. Graph-level optimization 124 takes the parsed computational graph from model analysis 120 and applies transformations to improve efficiency and simplify operations, without targeting any specific hardware. Hardware-specific optimization 164 can canonicalize operators, fuse compatible layers, remove redundant or dead computations, and annotate tensors with precision or quantization hints. These optimizations result in intermediate representation (IR) 170, which is a standardized, compiler-friendly format that encodes the neural network model as a set of normalized operations and typed data flows.

IR 170 can include a hardware-agnostic, lower-level encoding of the neural network, abstracting away framework-specific details. IR 170 serves as the foundation for subsequent hardware-specific optimization and code generation, ensuring the model is both efficient and ready for deployment on various accelerator architectures. IR 170 can serve as a bridge between high-level model description and hardware-specific instructions.

Hardware-specific optimization 164 can receive IR 170 to the constraints and capabilities of DNN accelerator 102. Hardware-specific optimization 164 can identify structural information and statistical information about the various layers and determine whether to map operations of individual layers to which hardware. Hardware-specific optimization 164 can adapt IR 170 of the neural network model to the constraints and capabilities of the target hardware accelerator (in this case, DNN accelerator 102). Hardware-specific optimization 164 can map each operation or layer to the most suitable hardware resources, selects appropriate data precisions, and applies scheduling strategies to maximize performance and efficiency. Hardware-specific optimization 164 may also adjust memory layouts, insert hardware-specific instructions, and fine-tune execution parameters to ensure the compiled model (e.g., configurations 190) runs optimally on the target hardware accelerator. Hardware-specific optimization 164 bridges the gap between generic model representation (e.g., IR 170) and the practical requirements of deployment on specialized target hardware accelerators.

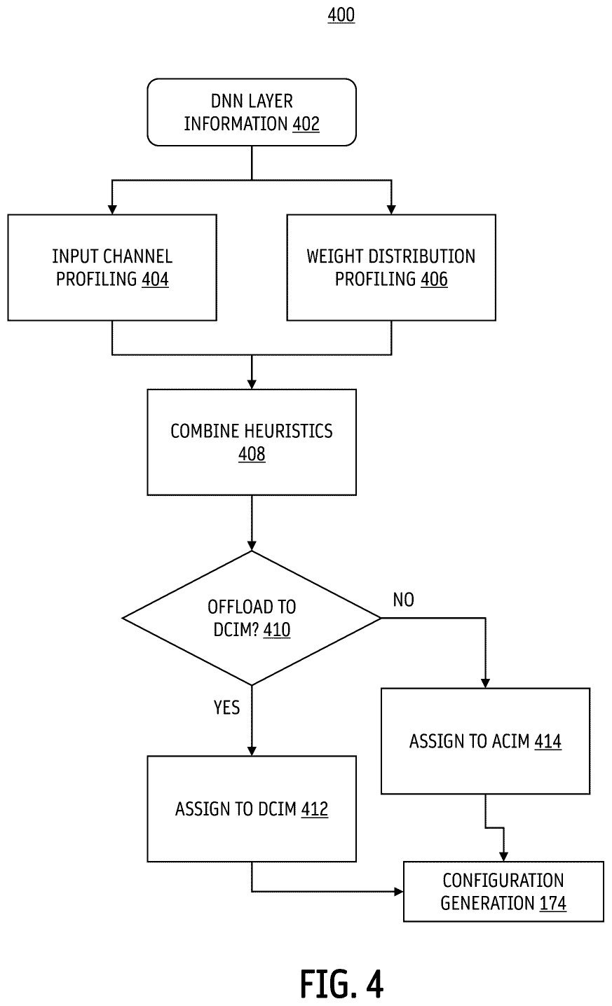

Hardware-specific optimization 164 can implement method 400 of FIG. 4. In some embodiments, hardware-specific optimization 164 can determine input channel counts, and weight distributions for each layer. Hardware-specific optimization 164 can perform structural and statistical profiling, as part of the layer-wise offloading technique to allow compiler 188 to flag layers that demand higher-precision or are vulnerable to analog non-idealities. Hardware-specific optimization 164 can allocate, assign, or map layers to different instances of compute engine 140 or different circuitry within an instance of compute engine 140, based on the precision needs and sensitivity of each layer. Hardware-specific optimization 164 can perform mapping of operations of a given layer based on one or more of: structural and statistical analysis. Hardware-specific optimization 164 can implement precision-aware offloading and enable hybrid analog-digital execution, ensuring the most sensitive layers are routed to digital, higher-precision circuitry for accuracy recovery. Hardware-specific optimization 164 can support layer-wise precision optimization, maximizing both accuracy and energy efficiency in neural network inference.

Configuration generation 174 can include producing deployment-ready configurations 190 for DNN accelerator 102. Configurations 190 can include the deployment-ready, machine-readable, instructions and parameters for the neural network accelerator. Configurations 190 can include the mapping of each layer to specific hardware resources, routing assignment, scheduling information, memory allocation details, input data shape information, output data shape information, including where to read and write data, operational parameters for the hardware resources, and precision settings. Configuration generation 174 ensures that the execution plan reflects the precision-aware mappings made in hardware-specific optimization 164, with explicit annotations for which layers are to be executed on which circuitry inserted in configurations 190.

DNN accelerator 102 can include one or more of: memory 104 and one or more instances of compute engine 140.

Memory 104 can include storage for configurations 190 and input data, intermediate data, and output data during inference. Memory 104 can hold weights, activations, and runtime parameters for compute engine 140. Memory 104 can store configurations 190 generated by compiler 188, which configures compute engine 140 to perform one or more specified operations based on specified data stored in memory 104 and generates data to be stored in memory 104.

Compute engine 140 can include specialized hardware units for performing neural network operations, such as matrix multiplication, convolution, and activation functions. Compute engine 140 can execute operations for layers assigned by compiler 188. Compute engine 140 may be instantiated multiple times within DNN accelerator 102 to support parallel execution and offer different execution paths for different layers.

One or more instances of compute engine 140 may perform compute operations for neural network models through different hardware architectures. For example, an instance of compute engine 140 may include an application-specific integrated circuit (ASIC) to perform operations with high efficiency. An instance of compute engine 140 may include a digital signal processor (DSP) for specialized operations. An instance of compute engine 140 may include a vector processor for parallel data handling and processing. An instance of compute engine 140 may include ACIM circuitry to perform computation directly within memory arrays. The precision of ACiM circuitry may vary depending on the resolution of the ADCs. An instance of compute engine 140 may include DCiM circuitry to perform computation directly within memory arrays higher-precision. An instance of compute engine 140 may include single instruction multiple data (SIMD) compute units. An instance of compute engine 140 can include a systolic array for highly parallel and high-throughput data processing.

The dual/multi-execution strategy described herein can be highly flexible and can be applied in several ways. For example, it can be used to selectively route neural network layers between ACIM circuitry with higher-precision ADCs and ACIM circuitry with lower precision ADCs, depending on each layer's sensitivity to quantization noise. Similarly, the strategy can partition computation between ACIM circuitry and DCIM circuitry, or other digital circuitry that offer different tradeoffs in accuracy and efficiency. In some cases, there are two execution paths to choose from to balance accuracy and efficiency. In some cases, there are more than two execution paths to choose from to balance accuracy, efficiency, and potentially other factors such as latency and availability.

This dual/multi-execution approach can be implemented within a single instance of compute engine 140 that supports multiple hardware architectures, dynamically switching between modes as directed by configurations 190. In some cases, the dual/multi-execution approach can operate across multiple instance of compute engine 140, each dedicated to or supporting one or more specific hardware architectures as directed by configurations 190. This flexibility enables fine-grained optimization of neural network inference, ensuring that precision-critical layers are utilizing optimal resources while maximizing overall energy efficiency.

During operation, DNN accelerator 102 receives configurations 190 from compiler 188 and executes the neural network according to configurations 190. Specifically, configurations 190 configures DNN accelerator 102 to perform operations of the neural network model, according to the mapping determined by compiler 188. DNN accelerator 102 can dynamically route data between instances of compute engine 140 or within an instance of compute engine 140 based on configurations 190, optimizing for both accuracy and energy efficiency.

### Dual Execution Paths in the DNN Accelerator

FIG. 2 illustrates compute engine 140 having DCiM 204 and ACIM 206, according to some embodiments of the disclosure. In particular, compute engine 140 illustrates a hybrid CiM architecture with hardware support for precision-aware offloading. Compute engine 140 comprises one or more of: input load unit 202, DCIM 204, ACIM 206, multiplexer 208, post-processing engine 230, and output drain unit 240. Compute engine 140 supports dual execution paths for neural network operations, enabling selective activation of either DCIM 204 or ACiM 206 for a given layer.

Input load unit 202 can include input circuitry for receiving and distributing input data associated with neural network operations or computations. Input load unit 202 can load activations, weights, and configuration signals into compute engine 140. Input load unit 202 can prepare data for processing by DCIM 204 or ACIM 206. Input load unit 202 can feed data to both DCiM 204 and ACIM 206 downstream.

DCiM 204 can include DCiM circuitry capable of performing neural network operations with high-precision. DCIM 204 can execute operations such as matrix multiplications, convolutions, MAC operations, and other digital operations. DCIM 204 can be powered on or activated when enabled by DCIM_EN signal. DCiM_EN signal is a control signal used to enable or activate DCIM 204. When DCIM_EN signal is asserted (set to an active state), DCIM 204 receives power and clock signals, allowing it to perform digital neural network operations. DCiM_EN signal can ensure that DCIM 204 is active during the execution of a layer assigned to the digital path, while ACIM 206 remains disabled, inactive, or in a lower power state, to prevent unnecessary power consumption. DCIM_EN signal can be generated based on information in the configurations produced by the compiler (e.g., configurations 190 compiler 188 of FIG. 1). DCIM_EN signal may participate in clock gating, power management, and functional isolation, ensuring that DCiM 204 operates only when activated and remains idle otherwise.

ACIM 206 can include ACIM circuitry optimized for energy-efficient neural network operations. ACIM 206 can execute operations such as matrix multiplications, convolutions, MAC operations, and other analog operations, leveraging lower precision for improved throughput-per-watt. ACIM 206 is enabled by ACiM_EN signal. ACIM 206 can be powered on or activated when enabled by ACIM_EN signal. ACIM_EN signal is a control signal used to enable or activate ACIM 206. When ACiM_EN signal is asserted (set to an active state), ACiM 206 receives power and clock signals, allowing it to perform analog compute-in-memory operations for neural network workloads. ACIM_EN signal can ensure that ACIM 206 is active during execution of a layer assigned to the analog path, while DCiM 204 remains disabled, inactive, or in a lower power state to prevent unnecessary power consumption. ACIM_EN signal can be generated based on information in the configurations produced by the compiler (e.g., configurations 190 from compiler 188 of FIG. 1). ACIM_EN signal may participate in clock gating, power management, and functional isolation, ensuring that ACIM 206 operates only when activated and remains idle otherwise.

Results, e.g., computed outputs, from either DCiM 204 or ACiM 206 are merged, via multiplexer 208 can propagate through a shared pipeline having post-processing engine 230 and output drain unit 240. Multiplexer 208 can include selection logic for routing the output from either DCiM 204 or ACiM 206 to downstream processing. Multiplexer 208 can receive a SELECT signal, and based on the SELECT signal, forwards the selected execution path's output to post-processing engine 230. The SELECT signal can be generated based on information in the configurations produced by the compiler (e.g., configurations 190 from compiler 188 of FIG. 1). The SELECT signal can be based on DCIM_EN and ACiM_EN.

Post-processing engine 230 can include circuitry for further processing the results of neural network computations. Post-processing engine 230 can apply activation functions, normalization, or other post-compute transformations to the data received from multiplexer 208.

Output drain unit 240 can include circuitry for collecting and exporting the final processed results from compute engine 140. Output drain unit 240 drain or write output data to memory, transmit results to other system components, or prepare data for further inference stages.

For each layer, machine-readable configurations (e.g., configurations 190 of FIG. 1) specify whether the digital or analog path of compute engine 140 (e.g., DCiM 204 or ACIM 206) should be used, and the corresponding enable signal (DCIM_EN or ACiM_EN) is asserted by control logic in compute engine 140 accordingly. DCiM_EN and ACIM_EN signals can enable controls for activating either DCIM 204 or ACIM 206, ensuring only one execution path is active for a given operation. DCiM_EN and ACiM_EN signals can do tasks such as gating power and clock signals to the respective compute-in-memory circuitry. SELECT signal, e.g., asserted by control logic in compute engine 140, can control multiplexer 208 to dictate or determining which execution path's output is forwarded for post-processing. SELECT signal can switch between execution paths in compute engine 140 (e.g., DCiM 204 and ACIM 206) based on hardware mapping decided by the compiler.

This architecture allows compute engine 140 to flexibly support dual execution paths within shared circuitry, allowing selective activation of either DCIM 204 and ACIM 206 to be used for each neural network layer, thereby optimizing for accuracy, efficiency, or other operational criteria.

From a hardware deployment perspective, the compiler-based layer-wise offloading strategy has an added benefit of enabling deterministic pipeline planning and resource allocation. Because the layer-to-hardware-circuitry mapping is known statically, the compiler can better schedule workloads to be performed by analog and digital compute paths without incurring unpredictable contention or latency spikes.

### Understanding Limitations of the ACIM Circuitry

FIG. 3 illustrates ACIM macro 300, according to some embodiments of the disclosure. ACiM macro 300 is a hardware block designed to accelerate neural network computations by performing MAC operations directly within memory arrays using analog signal processing. ACiM macro 300 can have M rows (for example, M=64), where each row receives digital input activations IAᵢ (e.g., IA₁, IA₂, . . . , IA_{M}) and stores weights Wᵢ (e.g., W₁, W₂, . . . , W_{M}) in memory cells. ACIM macro 300 can have N columns, with one or more shared ADCs (shared across time) or individual ADCs per column to digitize the analog output activation OAᵢ for the columns. This architecture enables high-throughput, energy-efficient computation for deep learning workloads, allowing large numbers of MAC operations to be parallelized and executed efficiently within memory. The effective accuracy of ACIM macro 300 depends on the ADC resolution and the utilization of the analog signal range, making it important to match hardware precision to the sensitivities of each neural network layer.

In operation, digital-to-Analog Converters (DACs) convert each digital input activation IAᵢ to an analog signal, which is then multiplied by the corresponding weight Wᵢ along the row. The analog products from each row are accumulated to produce an analog output activation OA for each column, where OA_{N}=Σ₍ᵢ₌₁₎^{M}(IAᵢ×Wᵢ). The accumulated analog output activation OA can have a theoretical precision of up to 21 bits, calculated as eight bits for IA, eight bits for W, 1 bit for sign, and log₂(M) bits for accumulation depth. However, the actual precision is limited by the resolution of the ADCs, which typically digitize the output OA to a lower bit-width (e.g., ^{˜}9-10 bits), potentially underutilizing the available dynamic range.

In ACiM macro 300, each row of the memory array performs analog accumulation across multiple ICs, followed by quantization of the accumulated result via an ADC. The effectiveness of this digitization process, specifically the ability of the ADC to represent the analog output accurately, is heavily influenced by the number of terms being summed in the accumulation. A high IC count leads to greater accumulation depth, higher signal amplitude, and broader dynamic range at the ADC input. In contrast, a low IC count results in weaker signals and limited variance, which significantly reduces ADC effectiveness. This creates two major challenges.

One challenge is ADC underutilization. When only a small number of input channels are present, the resulting analog accumulation has a reduced amplitude, occupying only a narrow fraction of the ADC's full-scale input range. Consequently, many of the ADC's quantization levels go unused, effectively lowering the resolution of the digitized output. For example, in an 11-bit ADC, if the signal utilizes only 25% of the full range, the effective resolution drops by approximately two bits. This means that precision is wasted on unused regions of the signal domain, degrading inference accuracy despite nominal ADC resolution.

Another challenge is noise dominance: In low signal conditions, analog noise sources such as thermal noise, device mismatch, supply ripple, and parasitic coupling begin to dominate the accumulated output. Because the ADC quantization step size is fixed, any analog noise that is comparable in magnitude to the signal becomes a significant contributor to digitization error. In such low signal-to-noise ratio (SNR) regimes, even small perturbations in the analog output can translate into large deviations after quantization, leading to unreliable inference results.

These effects are particularly problematic in the early layers of convolutional neural networks (CNNs) such as ResNet-50 or MobileNet-V2. These layers often process red-green-blue (RGB) input with as few as three channels, or early activations with 16 or 32 channels, resulting in extremely shallow analog accumulations. Given that many analog CiM architectures are optimized for an accumulation width of 128 input channels, layers with IC≤64 are effectively utilizing less than 50% of the analog accumulation depth. This results in both poor ADC utilization and increased vulnerability to analog noise.

### Dual Structural and Statistical Profiling Approach to Layer-Wise Offloading

It is not trivial to identify layers which are to be executed on the ACiM versus the DCIM. One or more heuristics can be used, such as input channel-based structural profiling and kurtosis-based sensitivity estimation. The heuristics may be complementary.

FIG. 4 illustrates layer information profiling and logic for determining whether a layer is to be executed on DCiM circuitry or ACIM circuitry, according to some embodiments of the disclosure. Specifically, method 400 is depicted, illustrating precision-aware offloading of sensitive layers to DCiM and robust layers to ACIM for optimized accuracy-efficiency tradeoff.

Method 400 includes receiving information about a layer of the neural network model, shown as DNN layer information 402. The information includes one or more of: a number of input channels of the layer, and a distribution of a plurality of weights of the layer. Method 400 can be repeated for one or more layers of the neural network model.

Input channel profiling 404 determines a structural heuristic for a layer based on DNN layer information 402. The structural heuristic may quantify or qualify the signal sensitivity of the layer to analog non-idealities.

Weight distribution profiling 406 determines a statistical heuristic for the layer based on DNN layer information 402. The statistical heuristic may quantify or qualify the statistical sensitivity or fragility of the layer in the presence of analog non-idealities.

Combine heuristics 408 combines or merges the structural heuristic (e.g., signal sensitivity) from input channel profiling 404 and the statistical heuristic (e.g., statistical sensitivity or fragility) from weight distribution profiling 406 together to form a combined or merged heuristic.

Based on the combined or merged heuristic, decision 410 determines whether the layer is to be executed by DCiM circuitry of the neural network accelerator or ACIM of the neural network accelerator. Decision 410 can determine whether to offload to DCIM or higher-precision circuitry. If YES, method proceeds to assign to DCiM 412. If NO, method proceeds to assign to ACIM 414.

Based on the assignment of the layer to the appropriate hardware circuitry, configuration generation 174 generates one or more machine-readable configurations for the one or more operations of the layer according to the determination. The one or more machine-readable configurations for the one or more operations of the layer can include one or more flags to enable execution on the DCiM or the ACiM.

In some embodiments, input channel profiling 404 determines whether the number of input channels meets a signal sensitivity condition. The signal sensitivity condition includes the number of input channels crossing a threshold.

Input channel profiling 404 thus determines or extracts a threshold-based IC profiling heuristic to statically identify structurally underutilized layers, e.g., where the accumulated signal at the input of the ADC is likely to have a low amplitude or magnitude. An underutilized ADC, e.g., digitizing a small input signal, can be more susceptible to noise. Specifically, any layer with an IC count below a predefined threshold (e.g., IC≤64) can be flagged as a candidate for offloading to DCiM circuitry or ACiM circuitry with higher-precision.

The intuition behind the threshold-based IC profiling heuristic implemented in input channel profiling 404 is that if the signal at the input of the ADC is less than half of the input range, then one bit of resolution of the ADC is lost or not utilized. If the signal at the input of the ADC is less than a quarter of the input range, then two bits of resolution of the ADC is lost or not utilized. If the IC count (IC) is significantly less than the full number of input channels being accumulated to form the input signal to the ADC (IC_{acc}), the resolution range of the ADC is likely going to be underutilized. Therefore, the threshold can be set at (½)*IC_{acc} to represent potentially one bit of the ADC resolution being underutilized because only half of the input channels are being used, (¼)*IC_{acc} to represent potentially two bits of the ADC resolution being underutilized because only a quarter of the input channels are being used, (⅛)*IC_{acc} to represent potentially three bits of the ADC resolution being underutilized because only an eighth of the input channels are being used, or (1/(2^{b}))*IC_{acc} to represent potentially b bits of the ADC resolution being underutilized. The threshold thus can be set based on the extent of the tolerance or sensitivity to ADC underutilization and the noise associated therewith.

The structural heuristic relating to signal sensitivity can be determined in input channel profiling 404 at compile time based on hardware-aware configuration parameters and does not require dynamic calibration or runtime monitoring. The advantage of this heuristic lies in its universality and zero runtime overhead. Analyzing IC count in input channel profiling 404 requires no forward pass data collection, profiling, or tuning, and can be integrated directly into the compiler (e.g., compiler 188 of FIG. 1) or deployment framework. Since IC counts are fixed architectural attributes, this heuristic scales across networks with varying depth, kernel size, and input resolution. For example, in edge-deployed convolutional neural networks that downsample aggressively in early layers, the IC-based heuristic can identify immediate flags for analog sensitivity/infeasibility and ensures those layers are mapped to reliable DCiM circuitry or higher-precision ACIM circuitry. Therefore, input channel profiling 404 represents a simple yet effective method that leverages readily available architectural metadata in DNN layer information 402 to identify layers that are inherently incompatible with efficient analog operation and generalizes well across models and CiM platforms.

While IC count captures structural limitations, IC count may not fully account for the statistical distribution of data flowing through the analog pipeline. To complement IC profiling, weight distribution profiling 406 analyzes the statistical distribution of the weights of the layer and determines whether the distribution of the plurality of weights meets a statistical sensitivity condition. In particular, a kurtosis-based sensitivity analysis can be adopted. The analysis can be performed offline on each layer's weight tensor. In some embodiments, weight distribution profiling 406 may determine one or more of a standard deviation (or variance) of the distribution, and a tailedness (e.g., representing Kurtosis) of the distribution.

In the context of analog accumulation in ACIM circuitry performing MAC operations, it is possible to make certain assumptions or expect certain characteristics about the accumulated signal range and the signal's sensitivity to quantization loss based upon one or more of: the mean, the standard deviation, and the variance of the weight distributions.

For example, assuming a zero (or near zero) mean for weight distribution for 8-bit quantized values, it is possible to set a critical threshold on the sigma σ (square root of variance or standard deviation) of the weight distribution. The critical threshold can be set where it is expected that the analog accumulation will not suffer from sensitivity to quantization loss.

Weight distribution profiling 406 determining whether the distribution of the plurality of weights meets a statistical sensitivity condition can involve determining whether a standard deviation σ of the distribution crosses the critical threshold σ_{crit}.

In one example, the critical threshold σ_{crit} on sigma σ is σ_{crit}=6σ≤2⁸/2 (the full magnitude range of an 8-bit signed, integer). In another example, the threshold on sigma σ is σ≤21.3 for one exemplary ACiM implementation. If the sigma σ of a neural network layer is greater than the critical threshold value σ_{crit}, then it is expected that the layer will be more susceptible to precision loss.

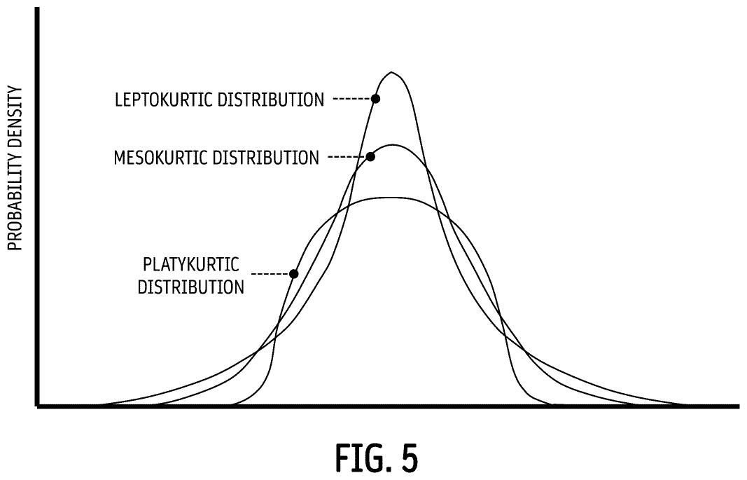

In some cases, a further piece of information about the weight distribution is examined, besides standard deviation. Standard deviation tells us how spread out the values are, but standard deviation alone does not show whether that spread comes from a few extreme outliers or just a wide range. This was shown in FIG. 5 where tailedness can vary significantly for distributions having the same mean and standard deviation. In some embodiments, kurtosis of the weight distribution is also examined or taken into account in weight distribution profiling 406.

Weight distribution profiling 406 determining whether the distribution of the plurality of weights meets a statistical sensitivity condition can involve evaluating whether a tailedness of the distribution crosses a confidence threshold (e.g., whether excess kurtosis>a confidence threshold, excess kurtosis>0, kurtosis>a confidence threshold or kurtosis>^{˜}3). The tailedness of the distribution can be quantified by a kurtosis-based measure.

Kurtosis, in probability theory and statistics, quantifies the “tailedness” of a probability distribution and is defined as the normalized fourth central moment, and can be calculated using the following equation:

$$Kurtosis = \frac{E [ {( X - μ )}^{4} ]}{{σ}^{4}}$$

Kurtosis is calculated by first finding the average (mean or μ) of the weights. Then, for each value, you measure how far it is from the mean, raise that difference to the fourth power, and average those results across all data points. This average is then divided by the fourth power of the standard deviation (σ⁴), which normalizes the result. The final value describes how much of the data is concentrated in the tails (far from the mean) compared to the center. High kurtosis means more extreme outliers; low kurtosis means the data is more evenly spread.

FIG. 5 illustrates distributions, e.g., Leptokurtic, Mesokurtic (normal), and Platykurtic distribution, having the same mean and standard deviation, but different kurtosis, according to some embodiments of the disclosure. This metric indicates the propensity of a distribution to produce outliers or extreme values. For instance, as illustrated in FIG. 5:
A mesokurtic or Gaussian (normal) distribution has kurtosis≈3 (representing excess kurtosis=0).
A platykurtic distribution (representing excess kurtosis<0) has lighter tails and fewer extreme values, indicating that the data is more evenly spread and less spiky.
A leptokurtic distribution (representing excess kurtosis>0) has heavier tails and more outliers.

As shown in FIG. 5, Leptokurtic distributions have a larger percentage of their distribution in the “tails”. Excess kurtosis is measured relative to the kurtosis of a mesokurtic or Gaussian (normal) distribution. In other words, excess kurtosis=kurtosis of distribution minus ^{˜}3.

In some embodiments, kurtosis, which measures the tailedness or the amount of outliers in a distribution, can be estimated in weight distribution profiling 406 using a histogram by examining the proportion of data points that fall into the extreme bins (far from the mean) compared to those near the center. If a histogram shows a high frequency of values in the outermost bins, this indicates heavy tails and higher kurtosis, meaning more outliers are present. Conversely, if most values are concentrated near the center and the tails are thin, the distribution has lower kurtosis. By calculating the ratio of counts in the tail bins to those in the central bins, weight distribution profiling 406 can obtain a crude measure of kurtosis without explicitly computing higher-order moments.

Kurtosis can be measured in addition to standard deviation because examining standard deviation alone may not paint the full picture of the weight distribution or correctly estimate the layer's sensitivity or fragility in the presence of analog non-idealities. As discussed above, kurtosis measures how much of the variation (i.e., the standard deviation or variance) is due to values far from the average (the “tails” of the distribution). If the distribution is leptokurtic (with heavy tails and more outliers, excess kurtosis>0), even a high standard deviation can be misleading: the predicted impact on analog performance may actually be worse than expected, because those outliers cause more degradation. On the other hand, if the distribution is platykurtic (with lighter tails, excess kurtosis<0), the prediction based on standard deviation alone might be too pessimistic.

Optimistic or pessimistic predictions matter in weight distribution profiling 406 because they directly affect how neural network layers are assigned to hardware. If the prediction about performance degradation is overly optimistic (for example, underestimating the negative impact of outliers in a leptokurtic distribution or excess kurtosis>0), layers may be mapped to analog hardware that cannot maintain the required accuracy, resulting in poor inference results. Conversely, if the prediction is too pessimistic (for example, overestimating the risk in a platykurtic distribution or excess kurtosis<0), layers may be unnecessarily assigned to higher-precision digital hardware, which increases power consumption and reduces efficiency. Predictions that take into account the tailedness of the distribution as a false positive check or false negative check can ensure that each layer is strategically mapped to the most suitable hardware path to accuracy and energy efficiency. Understanding whether predictions are optimistic or pessimistic helps avoid costly mistakes in hardware assignment and ensures reliable, efficient operation of the DNN accelerator.

Under this strategy, a layer may be marked as a candidate for offloading if weight distribution profiling 406 determines that the layer satisfies:
Condition 1: The sigma of the layer's weight distribution (σ) exceeds some critical threshold (σ_{crit}), and
Condition 2: Exhibits a leptokurtic distribution (excess kurtosis>0)

In some embodiments, a layer may be marked as a candidate for offloading if weight distribution profiling 406 determines that the layer satisfies one or more of condition 1 and condition 2. In some embodiments, a layer may be marked as a candidate for offloading if weight distribution profiling 406 determines that the layer satisfies both condition 1 and condition 2.

The result is a statistically rigorous, data-driven mechanism in weight distribution profiling 406 for identifying sensitivity to analog noise and quantization, independent of the evaluation of structural parameters like IC count in input channel profiling 404. In the compiler, weight distribution profiling 406 can calculate the mean, variance, and kurtosis for the weights of each layer based on DNN layer information 402 and use the statistics to evaluate whether the distribution of the weights meets a statistical sensitivity condition.

In some embodiments, a layer may be selected for offloading to DCiM circuitry in decision 410 if it satisfies either one of the following:
The number of input channels meeting a signal sensitivity condition: the input channel count crosses a predefined input channel threshold (e.g., IC≤64), indicating susceptibility to low signal amplitude and dynamic range compression during accumulation, and
The distribution of the weights meeting a statistical sensitivity condition: a high excess kurtosis value in its weight distribution (e.g., excess kurtosis>0), and a sigma σ exceeding a critical threshold (σ_{crit}), indicating vulnerability to analog quantization.

While input channel count and weight distribution kurtosis independently provide valuable insights into a layer's susceptibility to quantization noise, relying on either metric or heuristic in isolation may lead to suboptimal offloading decisions in some scenarios. For instance, a layer may have low input dimensionality but a weight distribution with significant outlier support, which can still benefit from analog accumulation. Conversely, a layer with a high number of input channels but an unusually peaked (leptokurtic) weight distribution may also yield fragile analog outputs. To address these corner cases, a hybrid/combined/merged heuristic is used to consider both structural and statistical properties to robustly determine offloading candidates.

In some embodiments, a layer may be selected for offloading to DCiM circuitry in decision 410 if it satisfies both of the following:
The number of input channels meeting a signal sensitivity condition: the input channel count crosses a predefined input channel threshold (e.g., IC≤64), indicating susceptibility to low signal amplitude and dynamic range compression during accumulation, and
The distribution of the weights meeting a statistical sensitivity condition: a high excess kurtosis value in its weight distribution (e.g., excess kurtosis>0), and a sigma σ exceeding a critical threshold (σ_{crit}), indicating vulnerability to analog quantization.

This intersectional criterion acts as a confidence filter, ensuring that only the most precision-sensitive layers are offloaded to DCiM circuitry or ACIM circuitry with a higher-precision ADC, thereby avoiding unnecessary diversion of layers that can still be handled effectively by ACiM circuitry. This also helps preserve the throughput advantage of ACIM by maximizing its usage wherever tolerable.

In some embodiments, a layer may be selected for execution using ACIM circuitry in decision 410 if it satisfies either one or both of the following:
The number of input channels not meeting a signal sensitivity condition: the input channel count does not cross a predefined input channel threshold (e.g., IC≤64), indicating little to no susceptibility to low signal amplitude and dynamic range compression during accumulation, and
The distribution of the weights not meeting a statistical sensitivity condition: a low excess kurtosis value in its weight distribution (e.g., excess kurtosis<0), and a sigma σ not exceeding a critical threshold (σ_{crit}), indicating little to no vulnerability to analog quantization.

Various operations in method 400 relate to one or more thresholds being used to identify layers as candidates for offloading onto DCiM circuitry. Thresholds, such as thresholds for input channel count, standard deviation, or kurtosis, can be tuned to balance accuracy and efficiency in neural network hardware deployment. To adjust these thresholds, it is possible to analyze the performance of DNN accelerator under different settings, observing how changes affect accuracy loss and energy consumption. For example, increasing the input channel threshold may result in more layers being offloaded to higher-precision hardware, improving accuracy but reducing efficiency. Similarly, raising the kurtosis-related threshold means only layers with more pronounced outliers are flagged for offloading, while lowering it makes the system more conservative. In some embodiments, thresholds can be set empirically by running benchmark models and measuring the tradeoff between accuracy and throughput-per-watt. The thresholds may be adjusted based on deployment requirements, such as stricter accuracy needs or tighter power budgets. In some cases, the thresholds may be adjusted based on impact of the analog non-idealities of the ACIM circuit under different levels of signal sensitivity conditions and/or statistical sensitivity conditions. In some cases, thresholds are fine tuned using validation data, optimizing for the best Pareto point between performance and resource usage. Adjusting thresholds allows system designers to tailor the hardware mapping strategy to the specific needs of the application and the characteristics of the neural network model.

The various hardware options represent different tradeoffs that can be made between efficiency and accuracy. While examples herein describe using a threshold (e.g., creating two sub-ranges) to select one of two hardware options to execute the operations of a layer, it is envisioned by the disclosure that multiple thresholds can be used (e.g., creating three or more sub-ranges) to select one of three hardware options to execute the operations of a layer.

### Example Application of Layer-Wise Offloading on ResNet-50

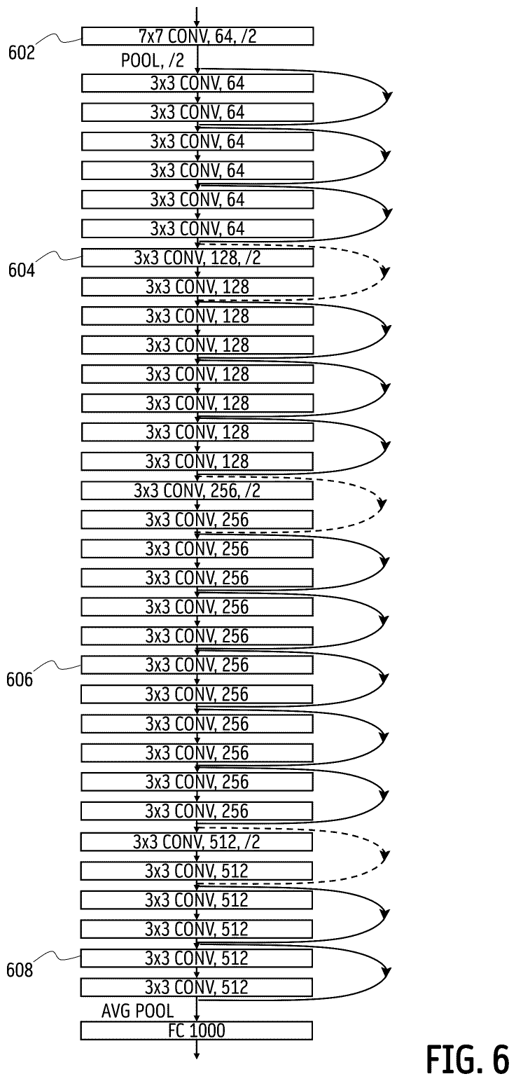

FIG. 6 illustrates selecting a subset of layers in ResNet-50 to be executed on DCIM circuitry, according to some embodiments of the disclosure. Selected layers, layer 602, layer 604, layer 606, and layer 608, are offloaded to the full-precision DCiM circuitry based on their structural underutilization and statistical sensitivity to quantization error. The remaining layers execute on the low-resolution ACIM circuitry, maintaining energy efficiency. This hybrid mapping strategy ensures high inference accuracy while preserving the throughput-per-watt advantage of analog compute.

Methods for Compiling a Neural Network Model with Layer-Wise Offloading Strategy

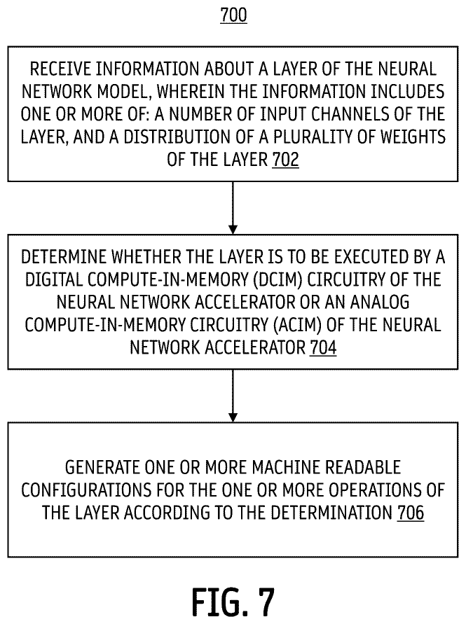

FIG. 7 is a flow diagram illustrating method 700 for compiling a neural network model to be executed on a neural network accelerator, according to some embodiments of the disclosure. Method 700 may be executed or carried out by compiler 188 of FIG. 1.

In 702, a compiler may receive information about a layer of the neural network model. The information can include one or more of: a number of input channels of the layer, and a distribution of a plurality of weights of the layer.

In 704, based on the information, the compiler can determine whether the layer is to be executed by DCIM circuitry of the neural network accelerator or ACIM circuitry of the neural network accelerator.

In 706, the compiler can generate one or more machine-readable configurations for the one or more operations of the layer according to the determination.

In some embodiments, determining whether the layer is to be executed by the DCIM circuitry or the ACM circuitry comprises determining whether the number of input channels meets a signal sensitivity condition. In some embodiments, the signal sensitivity condition comprises the number of input channels crossing a threshold.

In some embodiments, determining whether the layer is to be executed by the DCIM circuitry or the ACIM circuitry comprises determining whether the distribution of the plurality of weights meets a statistical sensitivity condition. In some embodiments, the statistical sensitivity condition comprises one or more of: a standard deviation of the distribution crossing a critical threshold, and a tailedness of the distribution crossing a confidence threshold. In some embodiments, the statistical sensitivity condition comprises a standard deviation of the distribution crossing a critical threshold, and a tailedness of the distribution crossing a confidence threshold. Tailedness can include a kurtosis of the distribution.

In some embodiments, determining whether the layer is to be executed by the DCIM circuitry or the ACIM circuitry comprises determining the layer is to be executed by the DCIM circuitry based on the number of input channels meeting a signal sensitivity condition or the distribution of the plurality of weights meeting the statistical sensitivity condition.

In some embodiments, determining the layer is to be executed by the DCiM circuitry based on the number of input channels meeting a signal sensitivity condition and the distribution of the plurality of weights meeting the statistical sensitivity condition.

In some embodiments, determining whether the layer is to be executed by the DCiM circuitry or the ACM circuitry comprises determining the layer is to be executed by the ACiM circuitry based on the number of input channels not meeting a signal sensitivity condition and/or the distribution of the plurality of weights not meeting the statistical sensitivity condition.

In some embodiments, the one or more machine-readable configurations for the one or more operations of the layer comprise one or more flags to enable execution on the DCIM or the ACiM.

### Exemplary Computing Device

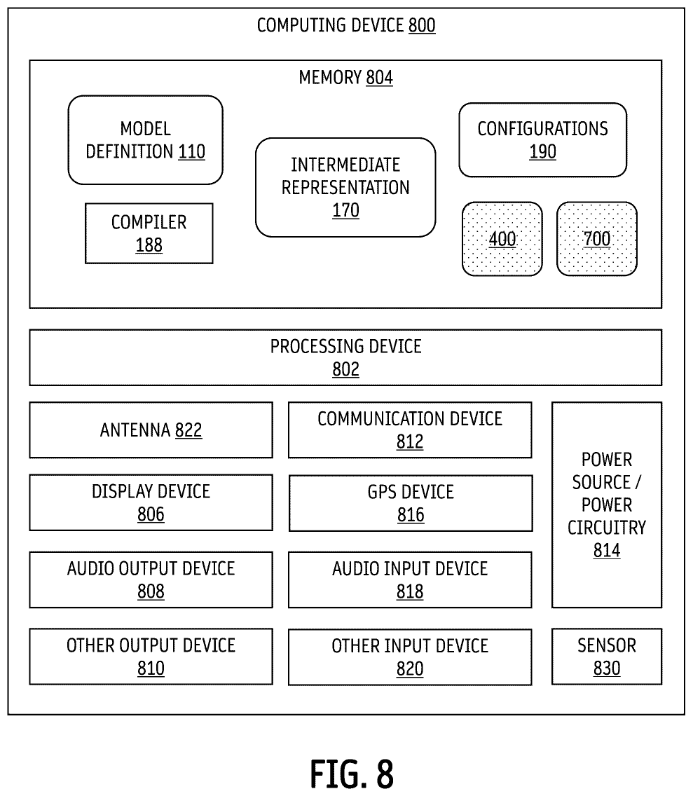

FIG. 8 is a block diagram of an apparatus or a system, e.g., an exemplary computing device 800, according to some embodiments of the disclosure. One or more computing devices 800 may be used to implement the functionalities described with the FIGS. and herein. A number of components illustrated in FIG. 8 can be included in the computing device 800, but any one or more of these components may be omitted or duplicated, as suitable for the application. In some embodiments, some or all of the components included in the computing device 800 may be attached to one or more motherboards. In some embodiments, some or all of these components are fabricated onto a single system on a chip (SoC) die. Additionally, in various embodiments, the computing device 800 may not include one or more of the components illustrated in FIG. 8, and the computing device 800 may include interface circuitry for coupling to the one or more components. For example, the computing device 800 may not include a display device 806, and may include display device interface circuitry (e.g., a connector and driver circuitry) to which a display device 806 may be coupled. In another set of examples, the computing device 800 may not include an audio input device 818 or an audio output device 808 and may include audio input or output device interface circuitry (e.g., connectors and supporting circuitry) to which an audio input device 818 or audio output device 808 may be coupled.

Computing device 800 may include a processing device 802 (e.g., one or more processing devices, one or more of the same types of processing device, one or more of different types of processing device). The processing device 802 may include electronic circuitry that processes electronic data from data storage elements (e.g., registers, memory, resistors, capacitors, quantum bit cells) to transform that electronic data into other electronic data that may be stored in registers and/or memory. Examples of processing device 802 may include a CPU, a GPU, a quantum processor, a machine learning processor, an artificial intelligence processor, a neural network processor, an artificial intelligence accelerator, an ASIC, an analog signal processor, an analog computer, a microprocessor, a digital signal processor, a field programmable gate array (FPGA), a tensor processing unit (TPU), a neural network hardware accelerator, a DNN hardware accelerator (e.g., having an architecture as illustrated in FIGS. 1-1 as described herein), etc.

Computing device 800 may include a memory 804, which may itself include one or more memory devices such as volatile memory (e.g., DRAM), non-volatile memory (e.g., read-only memory (ROM)), high bandwidth memory (HBM), flash memory, solid state memory, and/or a hard drive. Memory 804 includes one or more non-transitory computer-readable storage media. In some embodiments, memory 804 may include memory that shares a die with the processing device 802.

In some embodiments, memory 804 includes one or more non-transitory computer-readable media storing instructions executable to perform operations described with the FIGS. and herein. Memory 804 may include one or more non-transitory computer-readable media storing instructions executable to perform one or more operations described with method 400 of FIG. 4. Memory 804 may include one or more non-transitory computer-readable media storing instructions executable to perform one or more operations described with method 700 of FIG. 7. Exemplary parts, e.g., compiler 188, that may be encoded as instructions and stored in memory 804 are depicted. Compiler 188 may perform one or more operations relating to profiling to determine whether to execute or map a layer in the DCiM or ACiM. Compiler 188 may perform one or more operations illustrated in FIGS. 1 and 4. The instructions stored in the one or more non-transitory computer-readable media may be executed by processing device 802.

In some embodiments, memory 804 may store data, e.g., data structures, binary data, bits, metadata, files, blobs, etc., as described with the FIGS. and herein. Memory 804 may store inputs, intermediate inputs, intermediate outputs, and outputs the process illustrated in FIG. 4. Memory 804 may store one or more of: model definition 110, IR 170, and configurations 190.

In some embodiments, memory 804 may store one or more DNNs (and or parts thereof). Memory 804 may store training data for training (trained) a DNN. Memory 804 may store instructions that perform operations associated with training a DNN. Memory 804 may store input data, output data, intermediate outputs, intermediate inputs of one or more DNNs. Memory 804 may store one or more parameters used by the one or more DNNs. Memory 804 may store information that encodes how nodes of the one or more DNNs are connected with each other. Memory 804 may store instructions to perform one or more operations of the one or more DNNs. Memory 804 may store a model definition that specifies one or more operations of a DNN. Memory 804 may store instructions, such as configurations 190, that are generated by compiler 188 based on the model definition.

In some embodiments, computing device 800 may include a communication device 812 (e.g., one or more communication devices). For example, communication device 812 may be configured for managing wired and/or wireless communications for the transfer of data to and from the computing device 800. The term “wireless” and its derivatives may be used to describe circuits, devices, systems, methods, techniques, communications channels, etc., that may communicate data through the use of modulated electromagnetic radiation through a nonsolid medium. The term does not imply that the associated devices do not contain any wires, although in some embodiments they might not. The communication device 812 may implement any of a number of wireless standards or protocols, including but not limited to Institute for Electrical and Electronic Engineers (IEEE) standards including Wi-Fi (IEEE 802.10 family), IEEE 802.16 standards (e.g., IEEE 802.16-2005 Amendment), Long-Term Evolution (LTE) project along with any amendments, updates, and/or revisions (e.g., advanced LTE project, ultramobile broadband (UMB) project (also referred to as “3GPP2”), etc.). IEEE 802.16 compatible Broadband Wireless Access (BWA) networks are generally referred to as WiMAX networks, an acronym that stands for worldwide interoperability for microwave access, which is a certification mark for products that pass conformity and interoperability tests for the IEEE 802.16 standards. The communication device 812 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication device 812 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication device 812 may operate in accordance with Code-division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication device 812 may operate in accordance with other wireless protocols in other embodiments. Computing device 800 may include an antenna 822 to facilitate wireless communications and/or to receive other wireless communications (such as radio frequency transmissions). Computing device 800 may include receiver circuits and/or transmitter circuits. In some embodiments, communication device 812 may manage wired communications, such as electrical, optical, or any other suitable communication protocols (e.g., the Ethernet). As noted above, communication device 812 may include multiple communication chips. For instance, a first communication device 812 may be dedicated to shorter-range wireless communications such as Wi-Fi or Bluetooth, and a second communication device 812 may be dedicated to longer-range wireless communications such as global positioning system (GPS), EDGE, GPRS, CDMA, WiMAX, LTE, EV-DO, or others. In some embodiments, a first communication device 812 may be dedicated to wireless communications, and a second communication device 812 may be dedicated to wired communications.

Computing device 800 may include power source/power circuitry 814. The power source/power circuitry 814 may include one or more energy storage devices (e.g., batteries or capacitors) and/or circuitry for coupling components of the computing device 800 to an energy source separate from the computing device 800 (e.g., DC power, AC power, etc.).

Computing device 800 may include a display device 806 (or corresponding interface circuitry, as discussed above). The display device 806 may include any visual indicators, such as a heads-up display, a computer monitor, a projector, a touchscreen display, a liquid crystal display (LCD), a light-emitting diode display, or a flat panel display, for example.

Computing device 800 may include an audio output device 808 (or corresponding interface circuitry, as discussed above). The audio output device 808 may include any device that generates an audible indicator, such as speakers, headsets, or earbuds, for example.

Computing device 800 may include an audio input device 818 (or corresponding interface circuitry, as discussed above). The audio input device 818 may include any device that generates a signal representative of a sound, such as microphones, microphone arrays, or digital instruments (e.g., instruments having a musical instrument digital interface (MIDI) output).

Computing device 800 may include a GPS device 816 (or corresponding interface circuitry, as discussed above). The GPS device 816 may be in communication with a satellite-based system and may receive a location of the computing device 800, as known in the art.

Computing device 800 may include a sensor 830 (or one or more sensors). Computing device 800 may include corresponding interface circuitry, as discussed above). Sensor 830 may sense physical phenomenon and translate the physical phenomenon into electrical signals that can be processed by, e.g., processing device 802. Examples of sensor 830 may include: capacitive sensor, inductive sensor, resistive sensor, electromagnetic field sensor, light sensor, camera, imager, microphone, pressure sensor, temperature sensor, vibrational sensor, accelerometer, gyroscope, strain sensor, moisture sensor, humidity sensor, distance sensor, range sensor, time-of-flight sensor, pH sensor, particle sensor, air quality sensor, chemical sensor, gas sensor, biosensor, ultrasound sensor, a scanner, etc.

Computing device 800 may include another output device 810 (or corresponding interface circuitry, as discussed above). Examples of the other output device 810 may include an audio codec, a video codec, a printer, a wired or wireless transmitter for providing information to other devices, haptic output device, gas output device, vibrational output device, lighting output device, home automation controller, or an additional storage device.

Computing device 800 may include another input device 820 (or corresponding interface circuitry, as discussed above). Examples of the other input device 820 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

Computing device 800 may have any desired form factor, such as a handheld or mobile computer system (e.g., a cell phone, a smart phone, a mobile internet device, a music player, a tablet computer, a laptop computer, a netbook computer, a personal digital assistant (PDA), a personal computer, a remote control, wearable device, headgear, eyewear, footwear, electronic clothing, etc.), a desktop computer system, a server or other networked computing component, a printer, a scanner, a monitor, a set-top box, an entertainment control unit, a vehicle control unit, a digital camera, a digital video recorder, an Internet-of-Things device, or a wearable computer system. In some embodiments, the computing device 800 may be any other electronic device that processes data.

### Select Examples

Example 1 provides an apparatus for compiling a neural network model to be executed on a neural network accelerator, including a processor; and a memory to store instructions, that when executed by the processor, cause the processor to: receive information about a layer of the neural network model, where the information includes one or more of: a number of input channels of the layer, and a distribution of a plurality of weights of the layer; based on the information, determine whether the layer is to be executed by a digital compute-in-memory (DCiM) circuitry of the neural network accelerator or an analog compute-in-memory circuitry (ACiM) of the neural network accelerator; and generate one or more machine-readable configurations for the layer according to the determination.

Example 2 provides the apparatus of example 1, where the processor determines whether the layer is to be executed by the DCIM circuitry or the ACIM circuitry by: determining whether the number of input channels meets a signal sensitivity condition.

Example 3 provides the apparatus of example 2, where the signal sensitivity condition includes the number of input channels crossing a threshold.

Example 4 provides the apparatus of any one of examples 1-3, where the processor determines whether the layer is to be executed by the DCIM circuitry or the ACIM circuitry by: determining whether the distribution of the plurality of weights meets a statistical sensitivity condition.

Example 5 provides the apparatus of example 4, where the statistical sensitivity condition includes one or more of: a standard deviation of the distribution crossing a critical threshold; and a tailedness of the distribution crossing a confidence threshold.

Example 6 provides the apparatus of example 4, where the statistical sensitivity condition includes a standard deviation of the distribution crossing a critical threshold; and a tailedness of the distribution crossing a confidence threshold.

Example 7 provides the apparatus of example 5 or 6, where the tailedness includes kurtosis of the distribution.

Example 8 provides the apparatus of any one of examples 1-7, where the processor determines whether the layer is to be executed by the DCIM circuitry or the ACM circuitry by: determining the layer is to be executed by the DCiM circuitry based on the number of input channels meeting a signal sensitivity condition and the distribution of the plurality of weights meeting a statistical sensitivity condition.

Example 9 provides the apparatus of any one of examples 1-8, where the processor determines whether the layer is to be executed by the DCIM circuitry or the ACIM circuitry by: determining the layer is to be executed by the ACIM circuitry based on the number of input channels not meeting a signal sensitivity condition and/or the distribution of the plurality of weights not meeting a statistical sensitivity condition.

Example 10 provides the apparatus of any one of examples 1-9, where the one or more machine-readable configurations for the layer include one or more flags to enable execution on the DCIM or the ACiM.

Example 11 provides one or more non-transitory computer-readable media storing instructions for compiling a neural network model to be executed on a neural network accelerator, that when executed by a processor, cause the processor to: receive information about a layer of the neural network model, where the information includes one or more of: a number of input channels of the layer, and a distribution of a plurality of weights of the layer; based on the information, determine whether the layer is to be executed by a digital compute-in-memory (DCiM) circuitry of the neural network accelerator or an analog compute-in-memory circuitry (ACiM) of the neural network accelerator; and generate one or more machine-readable configurations for the layer according to the determination.

Example 12 provides the one or more non-transitory computer-readable media of example 11, where the processor determines whether the layer is to be executed by the DCIM circuitry or the ACIM circuitry by: determining whether the number of input channels meets a signal sensitivity condition.

Example 13 provides the one or more non-transitory computer-readable media of example 12, where the signal sensitivity condition includes the number of input channels crossing a threshold.

Example 14 provides the one or more non-transitory computer-readable media of any one of examples 11-13, where determining whether the layer is to be executed by the DCIM circuitry or the ACIM circuitry includes determining whether the distribution of the plurality of weights meets a statistical sensitivity condition.

Example 15 provides the one or more non-transitory computer-readable media of example 14, where the statistical sensitivity condition includes one or more of: a standard deviation of the distribution crossing a critical threshold; and a tailedness of the distribution crossing a confidence threshold.

Example 16 provides the one or more non-transitory computer-readable media of example 14, where the statistical sensitivity condition includes a standard deviation of the distribution crossing a critical threshold; and a tailedness of the distribution crossing a confidence threshold.

Example 17 provides the one or more non-transitory computer-readable media of example 15 or 16, where the tailedness includes kurtosis of the distribution.

Example 18 provides the one or more non-transitory computer-readable media of any one of examples 11-17, where the processor determines whether the layer is to be executed by the DCiM circuitry or the ACIM circuitry by: determining the layer is to be executed by the DCiM circuitry based on the number of input channels meeting a signal sensitivity condition and the distribution of the plurality of weights meeting a statistical sensitivity condition.

Example 19 provides the one or more non-transitory computer-readable media of any one of examples 11-18, where the processor determines whether the layer is to be executed by the DCiM circuitry or the ACIM circuitry by: determining the layer is to be executed by the ACIM circuitry based on the number of input channels not meeting a signal sensitivity condition and/or the distribution of the plurality of weights not meeting a statistical sensitivity condition.

Example 20 provides the one or more non-transitory computer-readable media of any one of examples 11-19, where the one or more machine-readable configurations for the layer include one or more flags to enable execution on the DCIM or the ACiM.

Example 21 provides a method for compiling a neural network model to be executed on a neural network accelerator: receiving information about a layer of the neural network model, where the information includes one or more of: a number of input channels of the layer, and a distribution of a plurality of weights of the layer; based on the information, determining whether the layer is to be executed by a digital compute-in-memory (DCIM) circuitry of the neural network accelerator or an analog compute-in-memory circuitry (ACiM) of the neural network accelerator; and generating one or more machine-readable configurations for the layer according to the determination.

Example 22 provides the method of example 21, where determining whether the layer is to be executed by the DCIM circuitry or the ACIM circuitry includes determining whether the number of input channels meets a signal sensitivity condition.

Example 23 provides the method of example 22, where the signal sensitivity condition includes the number of input channels crossing a threshold.

Example 24 provides the method of any one of examples 21-23, where determining whether the layer is to be executed by the DCiM circuitry or the ACIM circuitry includes determining whether the distribution of the plurality of weights meets a statistical sensitivity condition.

Example 25 provides the method of example 24, where the statistical sensitivity condition includes one or more of: a standard deviation of the distribution crossing a critical threshold; and a tailedness of the distribution crossing a confidence threshold.

Example 26 provides the method of example 25, where the statistical sensitivity condition includes a standard deviation of the distribution crossing a critical threshold; and a tailedness of the distribution crossing a confidence threshold.

Example 27 provides the method of example 25 or 26, where the tailedness includes a kurtosis of the distribution.

Example 28 provides the method of any one of examples 21-27, where determining whether the layer is to be executed by the DCIM circuitry or the ACIM circuitry includes determining the layer is to be executed by the DCIM circuitry based on the number of input channels meeting a signal sensitivity condition and the distribution of the plurality of weights meeting a statistical sensitivity condition.

Example 29 provides the method of any one of examples 21-28, where determining whether the layer is to be executed by the DCiM circuitry or the ACIM circuitry includes determining the layer is to be executed by the ACIM circuitry based on the number of input channels not meeting a signal sensitivity condition and/or the distribution of the plurality of weights not meeting a statistical sensitivity condition.

Example 30 provides the method of any one of examples 21-29, where the one or more machine-readable configurations for the layer include one or more flags to enable execution on the DCIM or the ACiM.

Example 31 provides an apparatus including means for performing a method according to any one of examples 21-30.

Example 32 provides a computer program product including instructions which, when executed by a processor, cause the processor to perform a method according to any one of examples 21-30.

Example 33 provides machine-readable storage including machine-readable instructions, when executed, cause a computer to implement a method according to any one of examples 21-30.

Example 34 provides a computer program including instructions which, when the computer program is executed by a processing device, cause the processing device to carry out a method according to any one of examples 21-30.

Example 35 provides a computer-implemented system, including one or more processors, and one or more non-transitory computer-readable media storing instructions that, when executed by the one or more processors, cause the one or more processors to perform a method according to any one of examples 21-30.

### Variations and Other Notes

As used herein, the term “coupled to” or “coupled with” refers to a relationship between electronic components or circuit elements wherein the components are in electronic communication with one another and capable of transmitting and/or receiving electrical signals between them. The term “coupled to” does not require a direct physical or electrical connection between the coupled components. Rather, “coupled to” can encompass arrangements where the components are connected through one or more intervening elements, components, circuits, or transmission paths. For example, a first component may be “coupled to” a second component through intermediate components such as resistors, capacitors, inductors, transistors, logic gates, buses, transformers, or other electronic components, or through intermediate transmission paths, while still maintaining the capability for electronic communication between the first and second components.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

For purposes of explanation, specific numbers, materials and configurations are set forth in order to provide a thorough understanding of the illustrative implementations. However, it will be apparent to one skilled in the art that the present disclosure may be practiced without the specific details and/or that the present disclosure may be practiced with only some of the described aspects. In other instances, well known features are omitted or simplified in order not to obscure the illustrative implementations.

Further, references are made to the accompanying drawings that form a part hereof, and in which are shown, by way of illustration, embodiments that may be practiced. It is to be understood that other embodiments may be utilized, and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the disclosed subject matter. However, the order of description should not be construed as to imply that these operations are necessarily order dependent. In particular, these operations may not be performed in the order of presentation. Operations described may be performed in a different order from the described embodiment. Various additional operations may be performed or described operations may be omitted in additional embodiments.

For the purposes of the present disclosure, the phrase “A or B” or the phrase “A and/or B” means (A), (B), or (A and B). For the purposes of the present disclosure, the phrase “A, B, or C” or the phrase “A, B, and/or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking or in any other manner.

In the following detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/−20% of a target value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value as described herein or as known in the art.

In addition, the terms “comprise,” “comprising,” “include,” “including,” “have,” “having” or any other variation thereof, are intended to cover a non-exclusive inclusion. For example, a method, process, or device, that comprises a list of elements is not necessarily limited to only those elements but may include other elements not expressly listed or inherent to such method, process, or device. Also, the term “or” refers to an inclusive “or” and not to an exclusive “or.”

The systems, methods and devices of this disclosure each have several innovative aspects, no single one of which is solely responsible for all desirable attributes disclosed herein. Details of one or more implementations of the subject matter described in this specification are set forth in the description and the accompanying drawings.

What is claimed:

1. An apparatus for compiling a neural network model to be executed on a neural network accelerator, comprising:
a processor; and
a memory to store instructions, that when executed by the processor, cause the processor to:
receive information about a layer of the neural network model, wherein the information includes one or more of: a number of input channels of the layer, and a distribution of a plurality of weights of the layer;
based on the information, determine whether the layer is to be executed by a digital compute-in-memory (DCiM) circuitry of the neural network accelerator or an analog compute-in-memory circuitry (ACiM) of the neural network accelerator; and
generate one or more machine-readable configurations for the layer according to the determination.

2. The apparatus of claim 1, wherein the processor determines whether the layer is to be executed by the DCIM circuitry or the ACIM circuitry by:
determining whether the number of input channels meets a signal sensitivity condition.

3. The apparatus of claim 2, wherein the signal sensitivity condition comprises the number of input channels crossing a threshold.

4. The apparatus of claim 1, wherein the processor determines whether the layer is to be executed by the DCiM circuitry or the ACIM circuitry by:
determining whether the distribution of the plurality of weights meets a statistical sensitivity condition.

5. The apparatus of claim 4, wherein the statistical sensitivity condition comprises one or more of:
a standard deviation of the distribution crossing a critical threshold; and
a tailedness of the distribution crossing a confidence threshold.

6. The apparatus of claim 5, wherein the tailedness comprises kurtosis of the distribution.

7. The apparatus of claim 1, wherein the processor determines whether the layer is to be executed by the DCIM circuitry or the ACIM circuitry by:
determining the layer is to be executed by the DCiM circuitry based on the number of input channels meeting a signal sensitivity condition and the distribution of the plurality of weights meeting a statistical sensitivity condition.

8. The apparatus of claim 1, wherein the processor determines whether the layer is to be executed by the DCIM circuitry or the ACIM circuitry by:
determining the layer is to be executed by the ACIM circuitry based on the number of input channels not meeting a signal sensitivity condition and/or the distribution of the plurality of weights not meeting a statistical sensitivity condition.

9. The apparatus of claim 1, wherein the one or more machine-readable configurations for the layer comprise one or more flags to enable execution on the DCIM or the ACiM.

10. One or more non-transitory computer-readable media storing instructions for compiling a neural network model to be executed on a neural network accelerator, that when executed by a processor, cause the processor to:
receive information about a layer of the neural network model, wherein the information includes one or more of: a number of input channels of the layer, and a distribution of a plurality of weights of the layer;
based on the information, determine whether the layer is to be executed by a digital compute-in-memory (DCiM) circuitry of the neural network accelerator or an analog compute-in-memory circuitry (ACiM) of the neural network accelerator; and
generate one or more machine-readable configurations for the layer according to the determination.

11. The one or more non-transitory computer-readable media of claim 10, wherein the processor determines whether the layer is to be executed by the DCIM circuitry or the ACIM circuitry by:
determining whether the number of input channels meets a signal sensitivity condition.

12. The one or more non-transitory computer-readable media of claim 11, wherein the signal sensitivity condition comprises the number of input channels crossing a threshold.

13. The one or more non-transitory computer-readable media of claim 10, wherein determining whether the layer is to be executed by the DCiM circuitry or the ACIM circuitry comprises:
determining whether the distribution of the plurality of weights meets a statistical sensitivity condition.

14. The one or more non-transitory computer-readable media of claim 13, wherein the statistical sensitivity condition comprises one or more of:
a standard deviation of the distribution crossing a critical threshold; and
a tailedness of the distribution crossing a confidence threshold.

15. The one or more non-transitory computer-readable media of claim 14, wherein the tailedness comprises kurtosis of the distribution.

16. A method for compiling a neural network model to be executed on a neural network accelerator:
receiving information about a layer of the neural network model, wherein the information includes one or more of: a number of input channels of the layer, and a distribution of a plurality of weights of the layer;
based on the information, determining whether the layer is to be executed by a digital compute-in-memory (DCiM) circuitry of the neural network accelerator or an analog compute-in-memory circuitry (ACiM) of the neural network accelerator; and
generating one or more machine-readable configurations for the layer according to the determination.

17. The method of claim 16, wherein determining whether the layer is to be executed by the DCiM circuitry or the ACIM circuitry comprises:
determining whether the number of input channels meets a signal sensitivity condition.

18. The method of claim 16, wherein determining whether the layer is to be executed by the DCiM circuitry or the ACIM circuitry comprises:
determining whether the distribution of the plurality of weights meets a statistical sensitivity condition.

19. The method of claim 16, wherein determining whether the layer is to be executed by the DCiM circuitry or the ACIM circuitry comprises:
determining the layer is to be executed by the DCiM circuitry based on the number of input channels meeting a signal sensitivity condition and the distribution of the plurality of weights meeting a statistical sensitivity condition.

20. The method of claim 18, wherein determining whether the layer is to be executed by the DCIM circuitry or the ACIM circuitry comprises:
determining the layer is to be executed by the ACIM circuitry based on the number of input channels not meeting a signal sensitivity condition and/or the distribution of the plurality of weights not meeting a statistical sensitivity condition.
